(19) United States
(12) Patent Application Publication
(10) Pub. No.: US 2007/0174374 A1
(43) Pub. Date: Jul. 26, 2007

(54) PSEUDORANDOM NUMBER GENERATOR AND PSEUDORANDOM NUMBER GENERATION PROGRAM

(75) Inventor: Wataru Inoha, YOKOHAMA-SHI (JP)

Correspondence Address: NATH & ASSOCIATES, 112 South West Street, Alexandria, VA, 22314, US

(73) Assignee: VICTOR COMPANY OF JAPAN, LIMITED, YOKOHAMA-SHI (JP)

(21) Appl. No.: 10/587,753

(22) PCT Filed: Jan. 28, 2005
(86) PCT No.: PCT/JP05/01211

§ 371 Date: Jul. 28, 2006

(30) Foreign Application Priority Data
Jan. 30, 2004 (JP) 2004-023335

(51) Int. Cl. G06F 7/58

(52) U.S. Cl. 708/252

(57) ABSTRACT

A pseudorandom number generator (1) has a first linear feedback shift register (2), a second linear feedback shift register (3), an initial value generator (4), a polynomial coefficient generator (5), and a pseudorandom number output unit (6). The initial value generator (4) generates initial values and supplies the same to the first linear feedback shift register (2) and second linear feedback shift register (3). The polynomial coefficient generator (5) generates coefficients of a characteristic polynomial and supplies the same to the second linear feedback shift register (3). The pseudorandom number output unit (6) carries out exclusive-OR operations on bits sequentially provided by the first linear feedback shift register (2) and second linear feedback shift register (3), generates a pseudorandom number sequence, and outputs the same.

### TECHNICAL FIELD

The present invention relates to a pseudorandom number generator and pseudorandom number generation program for generating pseudorandom numbers used for cryptocommunication.

### Background Art

Data communication through telephone, radio, the Internet, and the like is presently carried out by encrypting communication data to protect the data from wiretapping or alteration third persons. A sender of data encrypts the data with an encryption key and transmits the encrypted data. A receiver receives the encrypted data, decrypts the data with a decryption key, and obtains the data. Even if a third person intercepts the data, the third person has no authentic decryption key, and therefore, is unable to decrypt or tamper with the data.

Cryptosystems include a common key cryptosystem and a public key cryptosystem. To best utilize the characteristics of these systems, one of them must be selected according to conditions of use. Any system guarantees the security of communication data with the use of an encryption key, which is generated by using a pseudorandom number so that the encryption key may not easily be guessed.

For example, a pseudorandom number generation method employing a linear feedback shift register is capable of generating a pseudorandom number sequence of long data length from a relatively short initial value for random number generation. This method allows a plurality of devices to generate the same pseudorandom numbers only by sharing an initial value. It is known that combining a plurality of linear feedback shift registers having primitive polynomials satisfying specific conditions as characteristic polynomials realizes a pseudorandom number generator that can generate unpredictable pseudorandom numbers. Without sharing an initial value, information for selecting a plurality of linear feedback shift registers may be shared to generate the same pseudorandom number sequence (for example, refer to Japanese Unexamined Patent Application Publication No. Hei-10-91066).

The pseudorandom number generator employing linear feedback shift registers, however, generates pseudorandom numbers according to a specific algorism even if it uses a combination of nonlinear operations. There is, therefore, a risk that pseudorandom numbers to be generated are guessed from an initial number or from part of a generated pseudorandom number sequence.

If pseudorandom numbers are generated by selecting some of the plurality of linear feedback shift registers, it will be difficult to predict a pseudorandom number sequence to be generated. Combining linear feedback shift registers having characteristic polynomials of optional coefficients has a problem that it generates a pseudorandom number sequence that is not always an M-sequence (maximum length sequence) and the same pseudorandom number sequence is repeatedly generated at short intervals. It is necessary, therefore, to prepare many polynomials satisfying specific conditions in advance, select some from among them, and combine the selected ones. This means that linear feedback shift registers that are not always used must be arranged to deteriorate efficiency.

### DISCLOSURE OF INVENTION

An object of the present invention is to provide a pseudorandom number generator and pseudorandom number generation program appropriate for cryptocommunication and capable of generating a pseudorandom number sequence that is hardly predicted even if a generated pseudorandom number sequence or transmitted/received data is observed.

In order to accomplish the object, a first aspect of the present invention provides a pseudorandom number generator for generating a pseudorandom number sequence of a predetermined bit length, comprising a first linear feedback shift register having m steps of shift registers to use a primitive polynomial as a characteristic polynomial thereof, set first initial values and first coefficients to the m steps of shift registers, and provide a bit string of a predetermined bit length; a second linear feedback shift register having n steps of shift registers to use a characteristic polynomial, set second initial values and second coefficients to the n steps of shift registers, and provide a bit string of a predetermined bit length; an initial value generator to generate, according to predetermined conditions, the first and second initial values and supply the first and second initial values respectively to the first linear feedback shift register and second linear feedback shift register; a polynomial coefficient generator to generate, according to predetermined conditions, the second coefficients set to the second linear feedback shift register and supply the second coefficients to the second linear feedback shift register; a primitive polynomial memory to store a plurality of primitive polynomials with identification information representative of the primitive polynomials, one of the primitive polynomials being used for the first linear feedback shift register; a primitive polynomial selector to select, according to predetermined conditions, one of the primitive polynomials stored in the primitive polynomial memory and supply coefficients of the primitive polynomial as the first coefficients to the first linear feedback shift register; and a pseudorandom number output unit to generate the pseudorandom number sequence of the predetermined bit length by carrying out bit-by-bit logical operations on the bit string provided by the first linear feedback shift register and the bit string provided by the second linear feedback shift register and output the pseudorandom number sequence.

According to a second aspect of the present invention that is based on the first aspect, the pseudorandom number generator comprises a communication unit to generate initial data including the identification information of the primitive polynomial selected by the primitive polynomial selector, the first and second initial values generated by the initial value generator, and the second coefficients generated by the polynomial coefficient generator, send the initial data to a second pseudorandom number generator, receive, if any, initial data from the second pseudorandom number generator, extract the first and second initial values from the received initial data, supply the extracted first and second initial values to the first linear feedback shift register and second linear feedback shift register, extract the second coefficients from the received initial data, supply the extracted second coefficients to the second linear feedback shift register, extract identification information of a primitive polynomial from the received initial data, and supply the extracted identification information to the primitive polynomial selector. The primitive polynomial selector selects one of the primitive polynomials stored in the primitive polynomial memory according to the identification information extracted by the communication unit and supplies coefficients of the primitive polynomial serving as the first coefficients to the first linear feedback shift register.

A third aspect of the present invention provides a pseudorandom number generation program for causing a computer to generate a pseudorandom number sequence of a predetermined bit length, the pseudorandom number generation program making the computer function as a first linear feedback shift register having m steps of shift registers to use a primitive polynomial as a characteristic polynomial thereof, set first initial values and first coefficients to the m steps of shift registers, and provide a bit string of a predetermined bit length; a second linear, feedback shift register having n steps of shift registers to use a characteristic polynomial, set second initial values and second coefficients to the n steps of shift registers, and provide a bit string of a predetermined bit length; initial value generation means for generating, according to predetermined conditions, the first and second initial values and supplying the first and second initial values respectively to the first linear feedback shift register and second linear feedback shift register; polynomial coefficient generation means for generating, according to predetermined conditions, the second coefficients set to the second linear feedback shift register and supplying the second coefficients to the second linear feedback shift register; primitive polynomial memory means for storing a plurality of primitive polynomials with identification information representative of the primitive polynomials, one of the primitive polynomials being used for the first linear feedback shift register; primitive polynomial selection means for selecting, according to predetermined conditions, one of the primitive polynomials stored in the primitive polynomial memory means and supplying coefficients of the primitive polynomial as the first coefficients to the first linear feedback shift register; and pseudorandom number output means for generating the pseudorandom number sequence of the predetermined bit length by carrying out bit-by-bit logical operations on the bit string provided by the first linear feedback shift register and the bit string provided by the second linear feedback shift register and outputting the pseudorandom number sequence.

According to a fourth aspect of the present invention that is based on the third aspect, the pseudorandom number generation program further makes the computer function as communication means for generating initial data including the identification information of the primitive polynomial selected by the primitive polynomial selection means, the first and second initial values generated by the initial value generation means, and the second coefficients generated by the polynomial coefficient generation means, sending the initial data to a second pseudorandom number generator, receiving, if any, initial data from the second pseudorandom number generator, extracting the first and second initial values from the received initial data, supplying the extracted first and second initial values to the first linear feedback shift register and second linear feedback shift register, extracting the second coefficients from the received initial data, supplying the extracted second coefficients to the second linear feedback shift register, extracting identification information of a primitive polynomial from the received initial data, and supplying the extracted identification information to the primitive polynomial selection means; and the primitive polynomial selection means selects one of the primitive polynomials stored in the primitive polynomial memory means according to the identification information extracted by the communication means and supplies coefficients of the primitive polynomial serving as the first coefficients to the first linear feedback shift register.

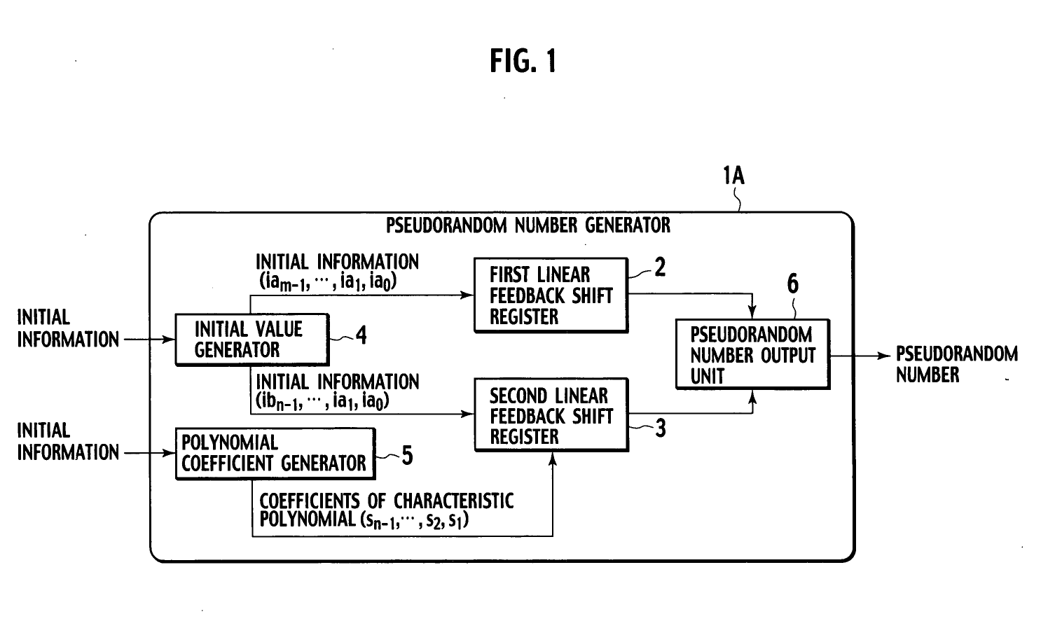

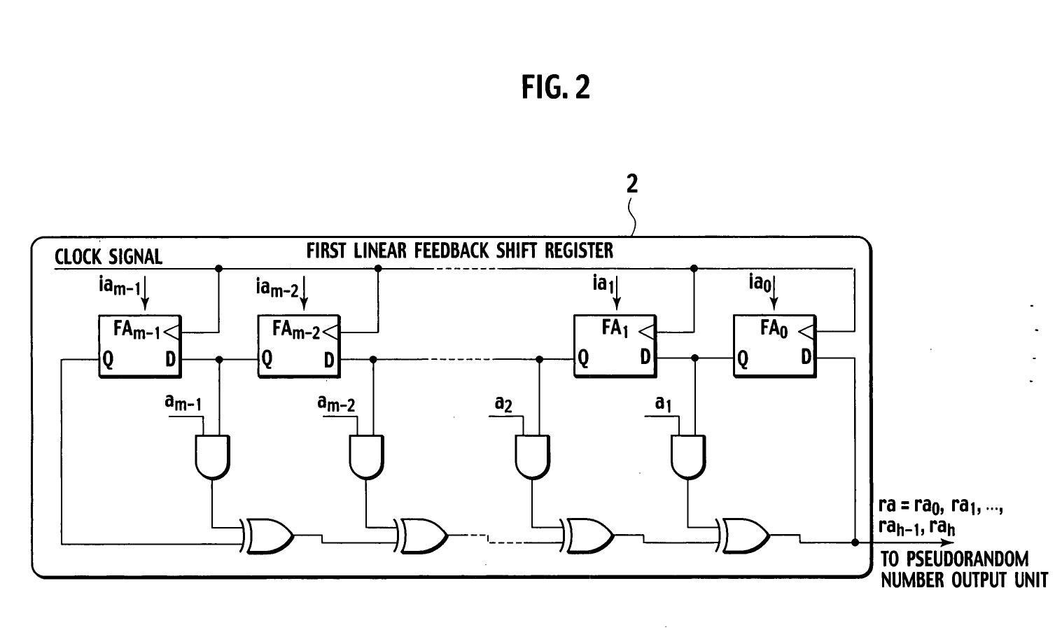

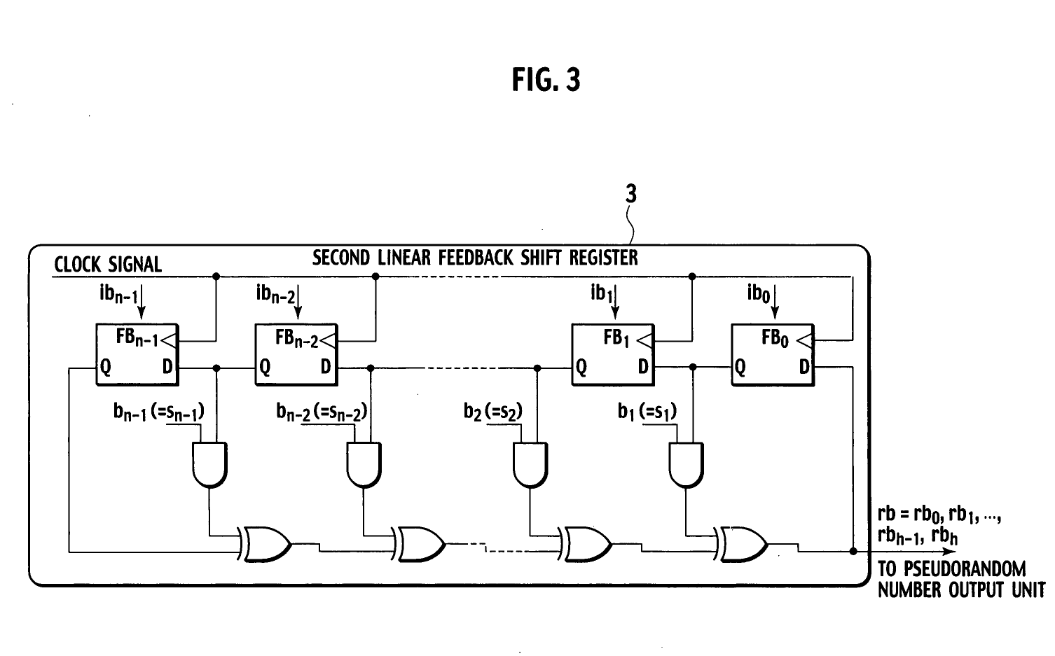

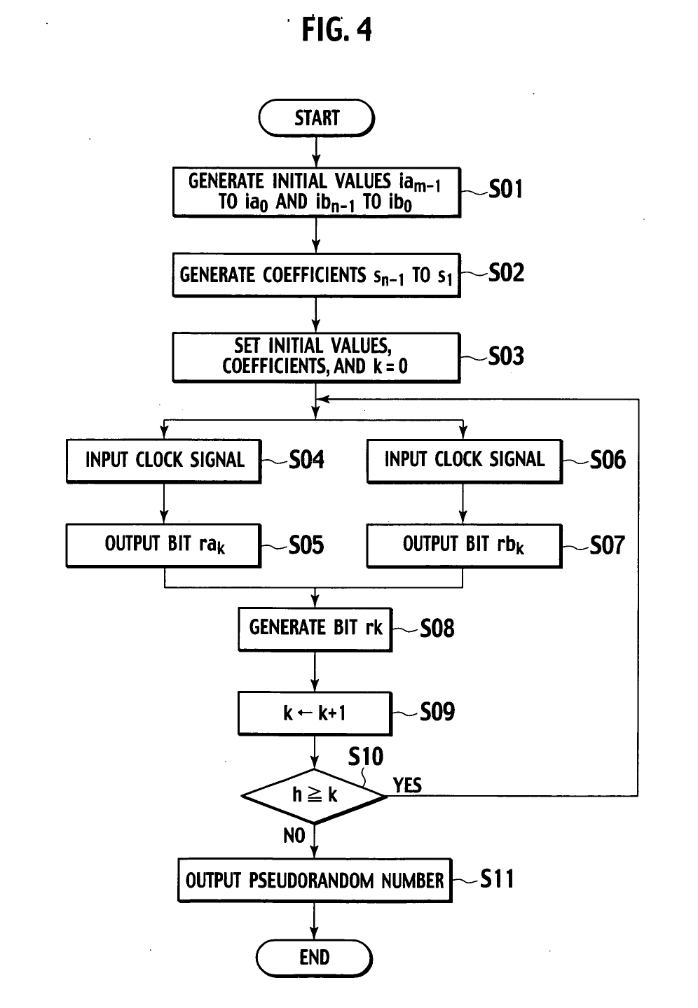

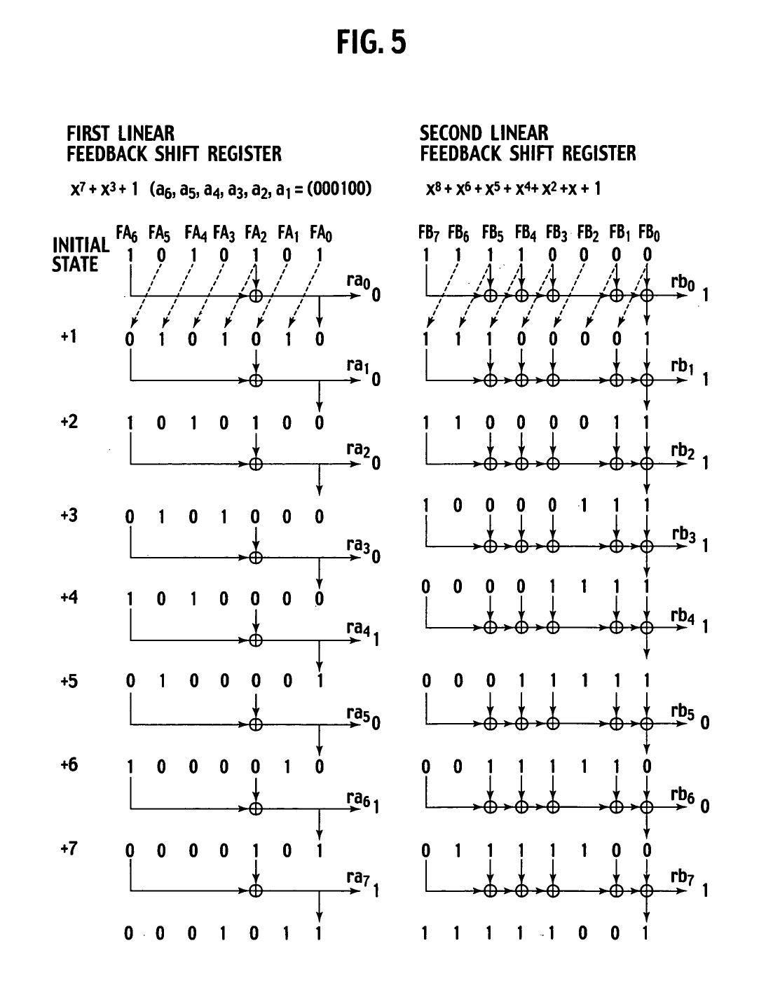

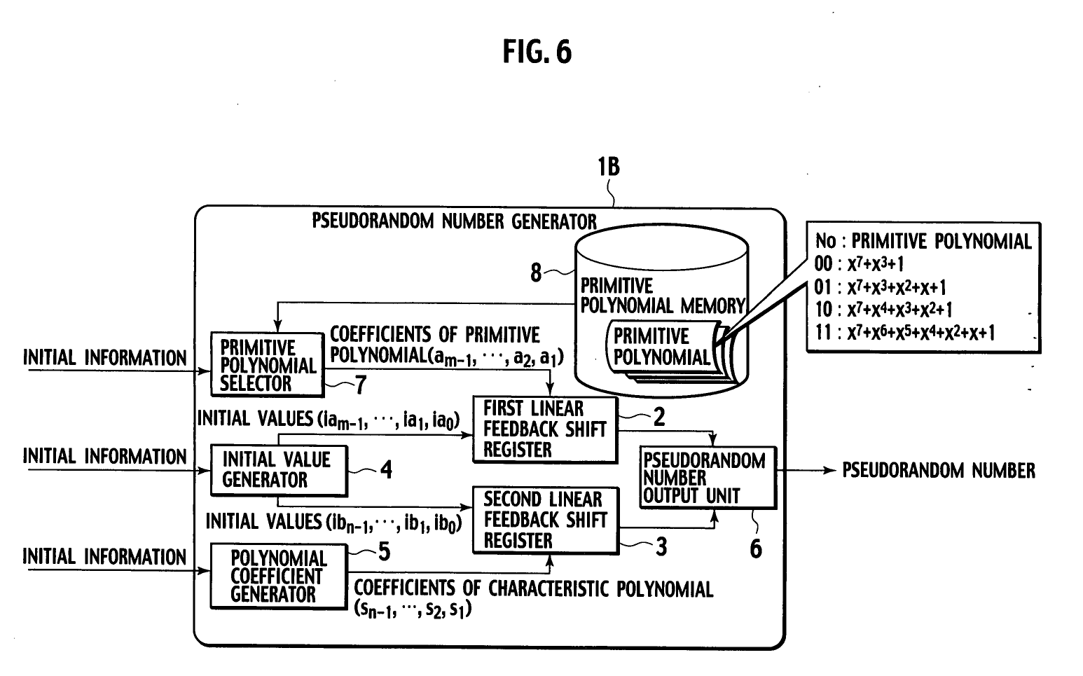

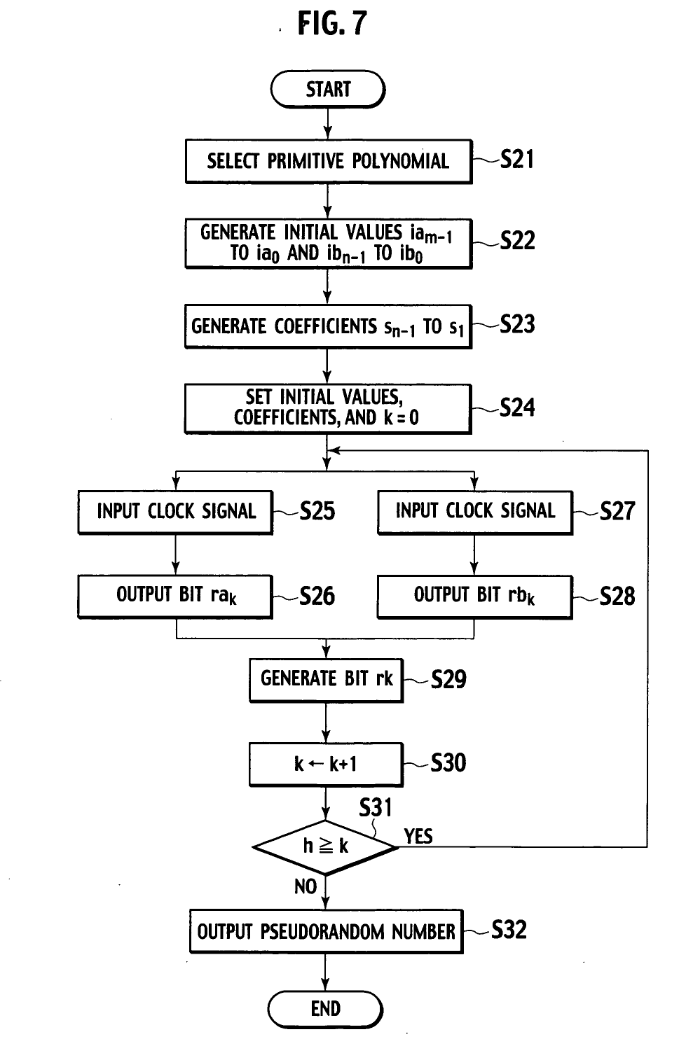

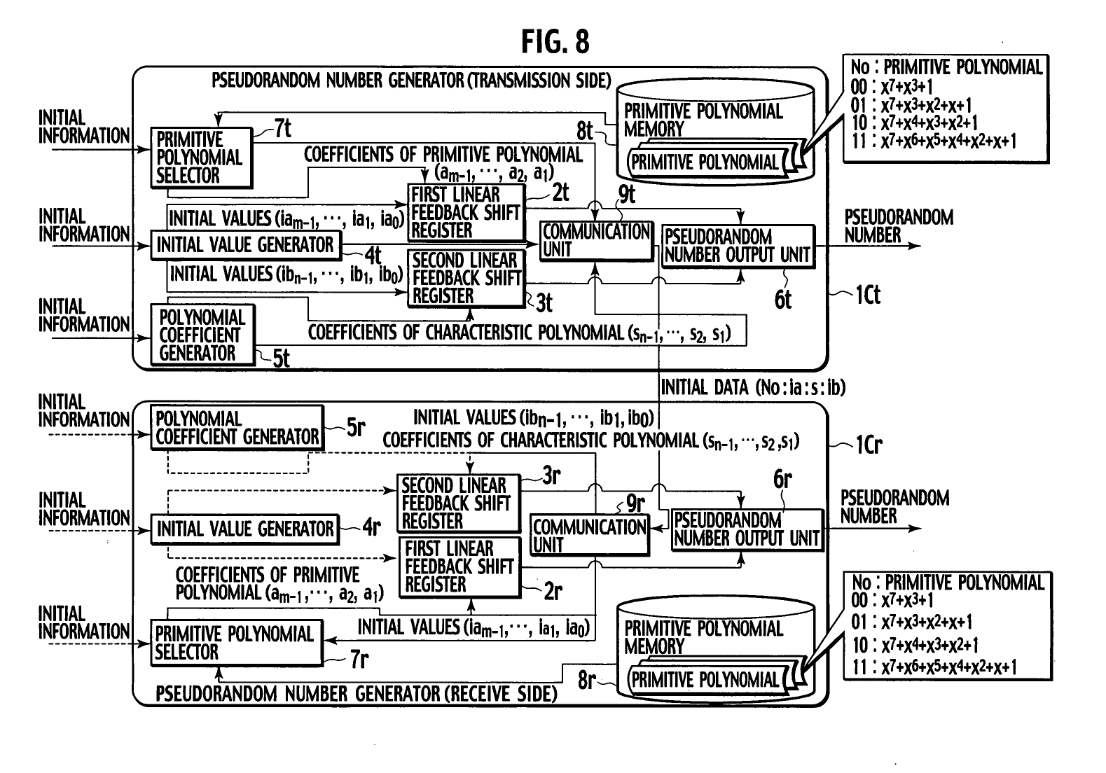

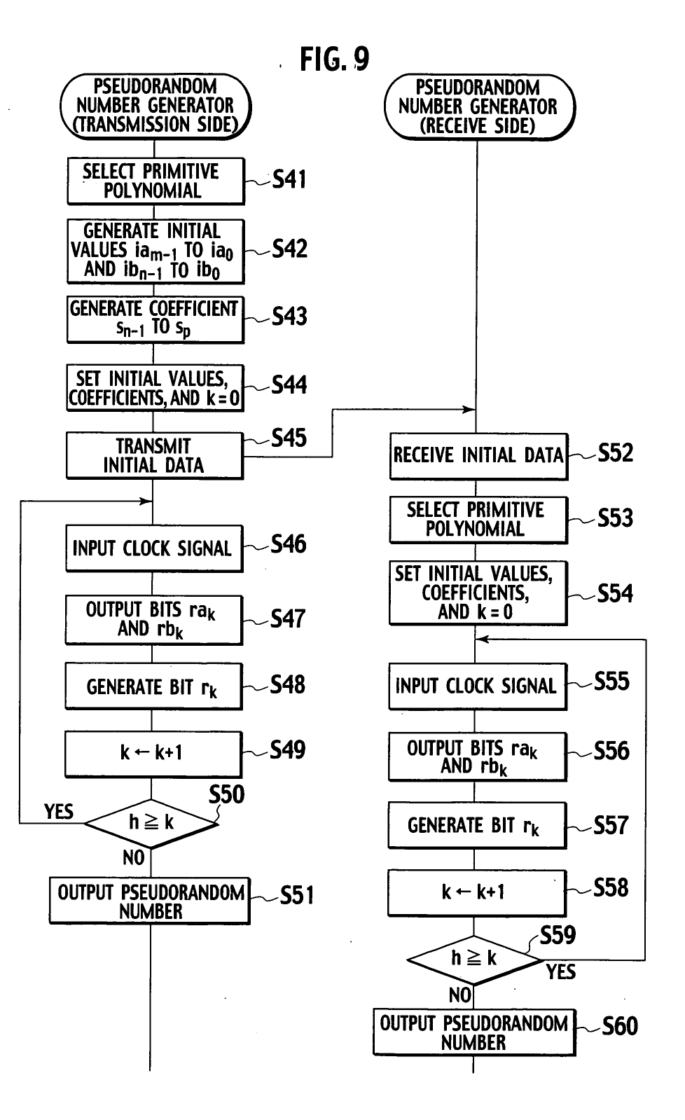

### BRIEF DESCRIPTION OF DRAWINGS

[FIG. 1] FIG. 1 is a functional diagram showing a pseudorandom number generator according to a first embodiment.

[FIG. 2] FIG. 2 is a circuit diagram showing a first linear feedback shift register.

[FIG. 3] FIG. 3 is a circuit diagram showing a second linear feedback shift register.

[FIG. 4] FIG. 4 is a flowchart showing a pseudorandom generation process according to the first embodiment.

[FIG. 5] FIG. 5 is a view showing changes in values of the first and second linear feedback shift registers.

[FIG. 6] FIG. 6 is a functional diagram showing a pseudorandom number generator according to a second embodiment.

[FIG. 7] FIG. 7 is a flowchart showing a pseudorandom number generation process according to the second embodiment.

[FIG. 8] FIG. 8 is a functional diagram showing a pseudorandom number generator according to a third embodiment.

[FIG. 9] FIG. 9 is a flowchart showing a pseudorandom number generation process according to the third embodiment.

### BEST MODE FOR CARRYING OUT THE INVENTION

Embodiments of the present invention will be explained with reference to FIGS. 1 to 9. The bit length of a pseudorandom number generated by a pseudorandom number generator 1 is h+1.

### FIRST EMBODIMENT

In FIG. 1, a pseudorandom number generator 1A according to the first embodiment has a first linear feedback shift register 2, a second linear feedback shift register 3, an initial value generator 4, a polynomial coefficient generator 5, and a pseudorandom number output unit 6.

The first linear feedback shift register 2 is an m-step linear feedback shift register having m flip-flop circuits (to be explained later in detail). The second linear feedback shift register 3 is an n-step linear feedback shift register having n flip-flop circuits (to be explained later in detail).

The initial value generator 4 has functions of using initial information to be provided externally or using predetermined conditions that may be obtained from always changing information such as date and time information or from physical phenomena such as heat, noise, and the like, generating initial values ia (iaₘ₋₁, iaₘ₋₂, . . . , ia₁, ia₀) accordingly for the flip-flops of the first linear feedback shift register 2, supplying them to the first linear feedback shift register 2, generating initial values ib (ibₙ₋₁, ibₙ₋₂, . . . , ib₁, ib₀) accordingly for the flip-flops of the second linear feedback shift register 3, and supplying them to the second linear feedback shift register 3. Not to make an output from the first linear feedback shift register 2 always “0,” at least one of the initial values iaₘ₋₁ to ia₀ must be “1.” Similarly, at least one of the initial values ibₙ₋₁ to ib₀ must be “1.”

The polynomial coefficient generator 5 has functions of using initial information to be provided externally or using predetermined conditions that may be obtained from always changing information such as date and time information or from physical phenomena such as heat, noise, and the like, generating coefficients s (sₙ₋₁, sₙ₋₂, . . . , s₂, s₁) accordingly for a characteristic polynomial of the second linear feedback shift register 3, and supplying them to the second linear feedback shift register 3.

The pseudorandom number output unit 6 has functions of receiving a bit string ra (ra₀, ra₁, . . . , raₕ₋₁, raₕ) sequentially provided by the first linear feedback shift register 2 and a bit string rb (rb₀, rb₁, . . . , rbₕ₋₁, rbₕ) sequentially provided by the second linear feedback shift register 3, operating exclusive ORs of the respective bits, generating a pseudorandom number r (r₀, r₁, . . . , rₕ₋₁, rₕ) of a predetermined bit length, and outputting the same.

In FIG. 2, the first linear feedback shift register 2 has the m flip-flop circuits, AND circuits, and XOR circuits. The characteristic polynomial of the first linear feedback shift register 2 is a predetermined primitive polynomial of aₘX^{m}+aₘ₋₁X^{m-1}+aₘ₋₂X^{m-2}+ . . . +a₂X²+a₁X+a₀ (where aₘ=1 and a₀=1). The coefficients a (aₘ₋₁, . . . , a₁) of the primitive polynomial are set to the AND circuits, respectively.

If aᵢ =0 (0<i<m), the AND circuit provides “0” without regard to a value provided by the flip-flop FAᵢ₋₁ (0<i<m), and if aᵢ=1 (0<i<m), provides the value provided by the flip-flop FAᵢ₋₁ (0<i<m).

In FIG. 3, the second linear feedback shift register 3 has the n flip-flop circuits, AND circuits, and XOR circuits. The characteristic polynomial of the second linear feedback shift register 3 may be bₙXⁿ+bₙ₋₁Xⁿ⁻¹+bₙ₋₂Xⁿ⁻²+ . . . +b₂X²+b₁X+b₀. Then, the coefficients b (bₙ₋₁, . . . , b₁=coefficients s) of the characteristic polynomial are set to the AND circuits, respectively.

Accordingly, if bⱼ=0 (0<j<n), the AND circuit provides “0” without regard to a value provided by the flip-flop FBj₁ (0<j<n), and if bⱼ=1 (0<j<n), provides the value provided by the flip-flop FBⱼ₋₁ (0<j<n).

Next, operation of the pseudorandom number generator 1A will be explained with reference to the flowchart of FIG. 4.

When the pseudorandom number generator 1A starts a pseudorandom number generation process, the initial value generator 4 generates (step S01) initial values ia (iaₘ₋₁, iaₘ₋₂, . . . , ia₁, ia₀) and initial values ib (ibₙ₋₁, ibₙ₋₂, . . . , ib₁, ib₀) according to externally provided initial information or predetermined conditions and supplies the initial values to the first linear feedback shift register 2 and second linear feedback shift register 3.

The polynomial coefficient generator 5 generates (step S02) coefficients s (sₙ₋₁, sₙ₋₂, . . . , S₂, s₁) for a characteristic polynomial of the second linear feedback shift register 3 according to externally provided initial information or predetermined conditions and supplies them to the second linear feedback shift register 3.

Once the initial value generator 4 and polynomial coefficient generator 5 supply the initial values and coefficients, the first linear feedback shift register 2 and second linear feedback shift register 3 set (step S03) the initial values and coefficients to the flip-flop circuits and AND circuits and a value k=0 to a counter k for counting the number of output bits. In the first linear feedback shift register 2, the initial values ia (iaₘ₋₁, iaₘ₋₂, . . . , ia₁, ia₀) are set to the flip-flop circuits FAₘ₋₁, FAₘ₋₂, . . . , FA₁, and FA₀, respectively, and the coefficients a (aₘ₋₁, . . . , a₁) of the primitive polynomial are set to the AND circuits, respectively. In the second linear feedback shift register 3, the initial values ib (ibₙ₋₁, ibₙ₋₂, . . . , ib₁, ib₀) are set to the flip-flop circuits FBₙ₋₁, FBₙ₋₂, . . . , FB₁, and FB₀, respectively, and the coefficients s (sₙ₋ᵢ, sₙ₋₂, . . . , s₂, s₁) of the characteristic polynomial are set to the AND circuits, respectively. In the second linear feedback shift register 3 of FIG. 3, bₙ=1 and b₀=1. Instead, AND circuits may be provided for bₙ and b₀ so that these coefficients may have optional values like the other coefficients.

The first linear feedback shift register 2 receives (step S04) a clock signal, carries out an operation, and provides (step S05) a bit raₖ. Similarly, the second linear feedback shift register 3 receives (step S06) a clock signal, carries out an operation, and provides (step S07) a bit rbₖ.

The pseudorandom number output unit 6 receives the bit raₖ from the first linear feedback shift register 2 and the bit rbₖ from the second linear feedback shift register 3, operates an exclusive OR of values of the bits, and generates (step S08) a bit rₖ.

Next, the first linear feedback shift register 2 and second linear feedback shift register 3 increment (step S09) the value of the counter k by one (k←k+1) and determine (step S10) whether or not the value of the counter k is higher than a value h. If the value of the counter k is equal to or less than h, the first linear feedback shift register 2 returns to step S04 and outputs a bit raₖ₊₁. Also, the second linear feedback shift register 3 returns to step S06 and outputs a bit rbₖ₊₁. Then, the pseudorandom number output unit 6 generates a bit rₖ₊₁.

If the value of the counter k is larger than h, the pseudorandom number generator 1 ends the pseudorandom number generation process and outputs (step S11) the generated bits r₀, r₁, . . . , rₕ₋₁, rₕ as a pseudorandom number r (r₀, r₁, . . . , rₕ₋₁, rₕ).

This will be explained in detail with reference to FIG. 5. As an example, an 8-bit pseudorandom number r is output. It is assumed that the primitive polynomial of the first linear feedback shift register 2 is X⁷+X³+1, the first linear feedback shift register 2 has seven steps of flip-flop circuits and the initial values ia (ia₆, ia₅, . . . , ia₁, ia₀)=(1, 0, 1, 0, 1, 0, 1), the second linear feedback shift register 3 has eight steps of flip-flop circuits and the initial values ib (ib₇, ib₆, . . . , ib₁, ib₀)=(1, 1, 1, 1, 0, 0, 0, 0), and the characteristic polynomial of the second linear feedback shift register 3 has coefficients (s₇, s₆, . . . , s₂, s₁)=(0, 1, 1, 1, 0, 1, 1).

When a first clock signal is input, the first linear feedback shift register 2 shifts the bits as FA₀→FA₁, FA₁→FA₂, . . . , FA₅→FA₆ to make (FA₆, FA₅, FA₄, FA₃, FA₂, FA₁)=(0, 1, 0, 1, 0, 1). The primitive polynomial of the first linear feedback shift register 2 is X⁷+X³+1, and therefore, the bit “1” of FA₆ and the bit “1” shifted from FA₂ to FA₃ are exclusive-ORed (XORed) into “0” which is fed back to FA₀ to establish a state “+1” of FIG. 5. As a result, the first linear feedback shift register 2 outputs “0” as ra₀.

When the first clock signal is input, the second linear feedback shift register 3 shifts the bits as FB₀→FB₁, FB₁→FB₂, . . . , FB₆→FB₇ to make (FB₇, FB₆, FB₅, FB₄, FB₃, FB₂, FB₁)=(1, 1, 1, 0, 0, 0, 0). The characteristic polynomial has the coefficients (s₇, s₆, . . . , s₁, s₀)=(0, 1, 1, 1, 0, 1, 1), and therefore, the characteristic polynomial is X⁸+X⁶+X⁵+X⁴+x²+X+1. The bit “1” shifted from FB₅ to FB₆, the bit “0” shifted from FB₃ to FB₄, the bit “0” shifted from FB₁ to FB₂, and the bit “0” shifted from FB₀ to FB₁ are XORed into “1” which is fed back to FB₀ to establish the state “+1” of FIG. 5. As a result, the second linear feedback shift register 3 outputs “1” as rb₀.

When a second clock signal is input, the first linear feedback shift register 2 and second linear feedback shift register 3 shift bits similarly, carry out feedback operations according to the primitive polynomial and characteristic polynomial, establish a state “+2” of FIG. 5, and output ra₁=0 and rb₁=1, respectively.

In this way, operations are repeated so that the first linear feedback shift register 2 outputs (ra₀, ra₁, . . . , ra₆, ra₇)=(0, 0, 0, 0, 1, 0, 1, 1) and the second linear feedback shift register 3 outputs (rb₀, rb₁, . . . , rb₆, rb₇)=(1, 1, 1, 1, 1, 0, 0, 1). (ra₀, ra₁, . . . , ra₆, ra₇)=(0, 0, 0, 0, 1, 0, 1, 1) and (rb₀, rb₁, . . . , rb₆, rb₇)=(1, 1, 1, 1, 1, 0, 0, 1) are XORed to output a pseudorandom number r (r₀, r₁, . . . , r₆, r₇)=(1, 1, 1, 1, 0, 0, 1, 0).

### SECOND EMBODIMENT

In FIG. 6, a pseudorandom number generator 1B according to the second embodiment has a first linear feedback shift register 2, a second linear feedback shift register 3, an initial value generator 4, a polynomial coefficient generator 5, a pseudorandom number output unit 6, a primitive polynomial selector 7, and a primitive polynomial memory 8. The same parts as those of the first embodiment are represented with the same numerals and their detailed explanations are omitted.

The primitive polynomial selector 7 has functions of referring to externally provided initial information, selecting one of primitive polynomials stored in the primitive polynomial memory 8 accordingly, and supplying coefficients a (aₘ₋₁, . . . , a₁) of the primitive polynomial serving as a characteristic polynomial to the first linear feedback shift register 2.

The primitive polynomial memory 8 stores a plurality of primitive polynomials with identification information, for setting AND circuits of the first linear feedback shift register 2. The identification information is to specify a primitive polynomial and may be a number, which will hereinafter be referred to as an identification number. The identification number can set the AND circuits with a smaller amount of information than the number of coefficients of a primitive polynomial. In FIG. 6, the primitive polynomial memory 8 uses identification numbers each having a bit length of two to identify primitive polynomials, such as an identification number “00” for X⁷+X³+1, an identification number “01” for X⁷+X³+X²+X+1, an identification number “10” for X⁷+X⁴+X³+X²+1, an identification number “11” for X⁷+X⁶+X⁵+X⁴+X²+X+1, and the like.

Operation of the pseudorandom number generator 1B will be explained with reference to a flowchart of FIG. 7.

When the pseudorandom number generator 1B starts a pseudorandom number generation process, the primitive polynomial selector 7 selects (step S21) one of the primitive polynomials of the primitive polynomial memory 8 according to externally provided initial information and supplies coefficients of the selected primitive polynomial as coefficients a (aₘ₋₁, . . . , a₁) of a characteristic polynomial to the first linear feedback shift register 2.

The initial value generator 4 generates (step S22) initial values ia (iaₘ₋₁, iaₘ₋₂, . . . , ia₁, ia₀) and initial values ib (ibₙ₋₁, ibₙ₋₂, . . . , ib₁, ib₀) according to externally provided initial information or predetermined conditions and supplies the initial values to the first linear feedback shift register 2 and second linear feedback shift register 3.

The polynomial coefficient generator 5 generates (step S23) coefficients s (sₙ₋₁, sₙ₋₂, . . . , s₂, s₁) for a characteristic polynomial of the second linear feedback shift register 3 according to externally provided initial information or predetermined conditions and supplies them to the second linear feedback shift register 3.

Once the primitive polynomial selector 7, initial value generator 4, and polynomial coefficient generator 5 supply the initial values and coefficients, the first linear feedback shift register 2 and second linear feedback shift register 3 set (step S24) the initial values and coefficients to the flip-flop circuits and AND circuits and a value k=0 to a counter k for counting the number of output bits. In the first linear feedback shift register 2, the initial values ia (iaₘ₋₁, iaₘ₋₂, . . . , ia₁, ia₀) are set to the flip-flop circuits FAₘ₋₁, FAₘ₋₂, . . . , FA₁, and FA₀, respectively, and the coefficients a (aₘ₋₁, . . . , a₁) of the characteristic polynomial supplied from the primitive polynomial selector 7 are set to the AND circuits, respectively. In the second linear feedback shift register 3, the initial values ib (ibₙ₋₁, ibₙ₋₂, . . . , ib₁, ib₀) are set to the flip-flop circuits FBₙ₋₁, FBₙ₋₂, . . . , FB₁, and FB₀, respectively, and the coefficients s (sₙ₋₁, sₙ₋₂, . . . , s₂, s₁) of the characteristic polynomial are set to the AND circuits, respectively. In the second linear feedback shift register 3 of FIG. 3, bₙ=1 and b₀=1. Instead, AND circuits may be provided for bₙ and b₀ so that these coefficients may have optional values like the other coefficients.

Thereafter, the same operations as those of the first embodiment (step S04 to step S11) are carried out to output a pseudorandom number r (r₀, r₁, . . . , rₕ₋₁, rₕ) (step S25 to step S32).

### THIRD EMBODIMENT

The third embodiment employs two pseudorandom number generators 1C. For example, one pseudorandom number generator 1 is arranged on a transmission side and the other pseudorandom number generator 1 is arranged on a receive side. The pseudorandom number generators 1C share characteristic polynomial coefficients and initial values (initial data), to generate the same pseudorandom number.

In FIG. 8, the pseudorandom number generator 1C according to the third embodiment has a first linear feedback shift register 2, a second linear feedback shift register 3, an initial value generator 4, a polynomial coefficient generator 5, a pseudorandom number output unit 6, a primitive polynomial selector 7, a primitive polynomial memory 8, and a communication unit 9. The same parts as those of the first and second embodiments are represented with the same numerals and their detailed explanations are omitted. For the sake of convenience, each component of the pseudorandom number generator 1 on the initial data transmission side is suffixed with a letter “t” and each component of the pseudorandom number generator 1 on the initial data receive side is suffixed with a letter “r.”

The communication unit 9 has functions of referring to an identification number representative of a primitive polynomial selected by the primitive polynomial selector 7, initial values ia (iaₘ₋₁, iaₘ₋₂, ia₁, ia₀) and initial values ib (ibₙ₋₁, ibₙ₋₂, . . . , ib₁, ib₀) generated by the initial value generator 4, and coefficients s (sₙ₋₁, sₙ₋₂, . . . , s₂, s₁) for a characteristic polynomial generated by the polynomial coefficient generator 5, generating initial data consisting of bit strings of the identification number of the primitive polynomial, the coefficients of the characteristic polynomial, and the initial values, and transmitting/receiving the initial data to/from the other pseudorandom number generator 1.

The communication unit 9 also has functions of extracting, from the initial data, the initial values ib (ibₙ₋₁, ibₙ₋₂, . . . , ib₁, ib₀) and coefficients s (sₙ₋₁, sₙ₋₂, . . . , s₂, s₁) of the characteristic polynomial, supplying them to the second linear feedback shift register 3, extracting the initial values ia (iaₘ₋₁, iaₘ₋₂, . . . , ia₁, ia₀) from the initial data, supplying them to the first linear feedback shift register 2, extracting the identification number of the primitive polynomial from the initial data, and supplying the same to the primitive polynomial selector 7.

Operation of generating the same pseudorandom number from the two pseudorandom number generators 1C will be explained with reference to the flowchart of FIG. 9.

When the pseudorandom number generator 1Ct starts a pseudorandom number generation process, the primitive polynomial selector 7t selects (step S41) one of the primitive polynomials of the primitive polynomial memory 8t according to externally provided initial information and supplies coefficients of the selected primitive polynomial as coefficients a (aₘ₋₁, . . . , a₁) of a characteristic polynomial to the first linear feedback shift register 2t and an identification number representative of the primitive polynomial to the communication unit 9t.

The initial value generator 4t generates (step S42) initial values ia (iaₘ₋₁, iaₘ₋₂, . . . , ia₁, ia₀) and initial values ib (ibₙ₋₁, ibₙ₋₂, . . . , ib₁, ib₀) according to externally provided initial information or predetermined conditions and supplies the initial values to the first linear feedback shift register 2t, second linear feedback shift register 3t, and communication unit 9t.

The polynomial coefficient generator 5t generates (step S43) coefficients s (sₙ₋₁, sₙ₋₂, . . . , s₂, s₁) for a characteristic polynomial of the second linear feedback shift register 3t according to externally provided initial information or predetermined conditions and supplies them to the second linear feedback shift register 3t and communication unit 9t.

Once the primitive polynomial selector 7t, initial value generator 4t, and polynomial coefficient generator 5t supply the initial values and coefficients, the first linear feedback shift register 2t and second linear feedback shift register 3t set (step S44) the initial values and coefficients to flip-flop circuits and AND circuits and a value k=0 to a counter k for counting the number of output bits. In the first linear feedback shift register 2t, the initial values ia (iaₘ₋₁, iaₘ₋₂, . . . , ia₁, ia₀) are set to the flip-flop circuits FAₘ₋₁, FAₘ₋₂, FA₁, and FA₀, respectively, and the coefficients a (aₘ₋₁, . . . , a₁) of the characteristic polynomial supplied from the primitive polynomial selector 7t are set to the AND circuits, respectively. In the second linear feedback shift register 3t, the initial values ib (ibₙ₋₁, ibₙ₋₂, . . . , ib₁, ib₀) are set to the flip-flop circuits FBₙ₋₁, FBₙ₋₂, . . . , FB₁, and FB₀, respectively, and the coefficients s (sₙ₋₁, sₙ₋₂, . . . , s₂, s₁) of the characteristic polynomial are set to the AND circuits, respectively. In the second linear feedback shift register 3 of FIG. 3, bₙ=1 and b₀=1. Instead, AND circuits may be provided for bₙ and b₀ so that these coefficients may have optional values like the other coefficients.

The communication unit 9t generates initial data consisting of the bit values of the identification number representative of the primitive polynomial, the bit values of the coefficients of the characteristic polynomial, and the bit values of the initial values and transmits (step S45) the initial data to the pseudorandom number generator 1Cr. At this time, the communication unit 9t may encrypt the initial data according to a given cipher method and transmit the encrypted initial data.

The identification number representative of the primitive polynomial may consist of two bits (“10”), the initial value ia seven bits (“1010101”), the initial value ib eight bits (“11110000”), and the coefficient s for the characteristic polynomial seven bits (“0111011”). In this case, the initial data is a 24-bit data string (identification number|initial value ia|initial value ib|coefficient s)=(101010101111100000111011).

Thereafter, the pseudorandom number generator 1Ct carries out the same operations as those of the first embodiment (step S04 to step S11) and outputs a pseudorandom number r (r₀, r₁, . . . , rₕ₋₁, rₕ) (step S46 to step S51).

On the other hand, the communication unit 9r of the pseudorandom number generator 1Cr receives (step S52) the initial data from the pseudorandom number generator 1Ct, extracts, from the received initial data, the initial values ib (ibₙ₋₁, ibₙ₋₂, . . . , ib₁, ib₀) and coefficients s (sₙ₋₁,sₙ₋₂, . . . , s₂, s₁) of the characteristic polynomial, supplies them to the second linear feedback register 3r, extracts the initial values ia (iaₘ₋₁, iaₘ₋₂, . . . , ia₁, ia₀) from the initial data, supplies them to the first linear feedback shift register 2r, extracts the identification number of the primitive polynomial from the initial data, and supplies the same to the primitive polynomial selector 7r. If the received initial data is encrypted, the communication unit 9 decrypts it into the initial data.

When the identification number of the primitive polynomial is supplied, the primitive polynomial selector 7r selects (step S53) one primitive polynomial corresponding to the identification number from the primitive polynomial memory 8r and supplies coefficients of the selected primitive polynomial as coefficients a (aₘ₋₁, . . . , a₁) of a characteristic polynomial to the first linear feedback shift register 2r.

Once the primitive polynomial selector 7r and communication unit 9r supply the initial values and coefficients, the first linear feedback shift register 2r and second linear feedback shift register 3r set (step S54) the initial values and coefficients to flip-flop circuits and AND circuits and a value k=0 to a counter k for counting the number of output bits.

Thereafter, the pseudorandom number generator 1Cr carries out the same operations as those of the first embodiment (step S04 to step S11) and outputs a pseudorandom number r (r₀, r₁, . . . , rₕ₋₁, rₕ) (step S55 to step S60).

In this way, the two pseudorandom number generators 1 share initial data and generate the same pseudorandom number.

The pseudorandom number generator 1 may be realized by making a general-purpose computer execute a pseudorandom number generation program describing the above-mentioned functions. The pseudorandom number generation program may be read from a storage medium and executed by a general-purpose computer, or may externally be transmitted through a network and executed by a general-purpose computer.

### INDUSTRIAL APPLICABILITY

According to the present invention, a pseudorandom number sequence longer than a given M-sequence can always be generated, and not only initial values but also coefficients of a characteristic polynomial can optionally be set. Even if the generated pseudorandom number sequence is observed, it is difficult to predict a pseudorandom number sequence to be generated. Accordingly, the safety of a pseudorandom number sequence is secured and the safety of data to be communicated is guaranteed. If correspondence between identification information and a primitive polynomial is unknown, it is difficult to decrypt data to be communicated.

A primitive polynomial set as a characteristic polynomial of the first linear feedback shift register is selected with identification information whose data amount for transmission is smaller than that of coefficients of the polynomial. Namely, the identification information whose data amount is smaller than that of the primitive polynomial itself helps reduce an information amount.

1. A pseudorandom number generator (1) for generating a pseudorandom number sequence of a predetermined bit length, comprising:
a first linear feedback shift register (2) having m steps of shift registers to use a primitive polynomial as a characteristic polynomial thereof, set first initial values and first coefficients to the m steps of shift registers, and provide a bit string of a predetermined bit length;
a second linear feedback shift register (3) having n steps of shift registers to use a characteristic polynomial, set second initial values and second coefficients to the n steps of shift registers, and provide a bit string of a predetermined bit length;
an initial value generator (4) to generate, according to predetermined conditions, the first and second initial values and supply the first and second initial values respectively to the first linear feedback shift register (2) and second linear feedback shift register (3);
a polynomial coefficient generator (5) to generate, according to predetermined conditions, the second coefficients set to the second linear feedback shift register (3) and supply the second coefficients to the second linear feedback shift register (3);
a primitive polynomial memory (8) to store a plurality of primitive polynomials with identification information representative of the primitive polynomials, one of the primitive polynomials being used for the first linear feedback shift register (2);
a primitive polynomial selector (7) to select, according to predetermined conditions, one of the primitive polynomials stored in the primitive polynomial memory (8) and supply coefficients of the primitive polynomial as the first coefficients to the first linear feedback shift register (2); and
a pseudorandom number output unit (6) to generate the pseudorandom number sequence of the predetermined bit length by carrying out bit-by-bit logical operations on the bit string provided by the first linear feedback shift register (2) and the bit string provided by the second linear feedback shift register (3) and output the pseudorandom number sequence.

2. The pseudorandom number generator as set forth in claim 1, wherein:
the pseudorandom number generator (1C) comprises a communication unit (9) to generate initial data including the identification information of the primitive polynomial selected by the primitive polynomial selector (7), the first and second initial values generated by the initial value generator (4), and the second coefficients generated by the polynomial coefficient generator (5), send the initial data to a second pseudorandom number generator (1C), receive, if any, initial data from the second pseudorandom number generator (1C), extract the first and second initial values from the received initial data, supply the extracted first and second initial values to the first linear feedback shift register (2) and second linear feedback shift register (3), extract the second coefficients from the received initial data, supply the extracted second coefficients to the second linear feedback shift register (3), extract identification information of a primitive polynomial from the received initial data, and supply the extracted identification information to the primitive polynomial selector (7); and
the primitive polynomial selector (7) selects one of the primitive polynomials stored in the primitive polynomial memory (8) according to the identification information extracted by the communication unit (9) and supplies coefficients of the primitive polynomial serving as the first coefficients to the first linear feedback shift register (2).

3. A pseudorandom number generation program for causing a computer to generate a pseudorandom number sequence of a predetermined bit length, the pseudorandom number generation program making the computer function as:
a first linear feedback shift register having m steps of shift registers to use a primitive polynomial as a characteristic polynomial thereof, set first initial values and first coefficients to the m steps of shift registers, and provide a bit string of a predetermined bit length;
a second linear feedback shift register having n steps of shift registers to use a characteristic polynomial, set second initial values and second coefficients to the n steps of shift registers, and provide a bit string of a predetermined bit length;
initial value generation means for generating, according to predetermined conditions, the first and second initial values and supplying the first and second initial values respectively to the first linear feedback shift register and second linear feedback shift register;
polynomial coefficient generation means for generating, according to predetermined conditions, the second coefficients set to the second linear feedback shift register and supplying the second coefficients to the second linear feedback shift register;
primitive polynomial memory means for storing a plurality of primitive polynomials with identification information representative of the primitive polynomials, one of the primitive polynomials being used for the first linear feedback shift register;
primitive polynomial selection means for selecting, according to predetermined conditions, one of the primitive polynomials stored in the primitive polynomial memory means and supplying coefficients of the primitive polynomial as the first coefficients to the first linear feedback shift register; and
pseudorandom number output means for generating the pseudorandom number sequence of the predetermined bit length by carrying out bit-by-bit logical operations on the bit string provided by the first linear feedback shift register and the bit string provided by the second linear feedback shift register and outputting the pseudorandom number sequence.

4. The pseudorandom number generation program as set forth in claim 3, wherein:
the pseudorandom number generation program further makes the computer function as communication means for generating initial data including the identification information of the primitive polynomial selected by the primitive polynomial selection means, the first and second initial values generated by the initial value generation means, and the second coefficients generated by the polynomial coefficient generation means, sending the initial data to a second pseudorandom number generator, receiving, if any, initial data from the second pseudorandom number generator, extracting the first and second initial values from the received initial data, supplying the extracted first and second initial values to the first linear feedback shift register and second linear feedback shift register, extracting the second coefficients from the received initial data, supplying the extracted second coefficients to the second linear feedback shift register, extracting identification information of a primitive polynomial from the received initial data, and supplying the extracted identification information to the primitive polynomial selection means; and
the primitive polynomial selection means selects one of the primitive polynomials stored in the primitive polynomial memory means according to the identification information extracted by the communication means and supplies coefficients of the primitive polynomial serving as the first coefficients to the first linear feedback shift register.
